(19) United States
(12) Patent Application Publication
(10) Pub. No.: US 2001/0037583 A1
(43) Pub. Date: Nov. 8, 2001

(54) Ball dryer

(76) Inventor: Douglas B. Stuckey, Newport Beach, CA (US)

Correspondence Address: Matthew J. Peirce, Esq., 1550 Starlight Canyon Avenue, Las Vegas, NV, 89123, US

(21) Appl. No.: 09/849,680

(22) Filed: May 4, 2001

Related U.S. Application Data
(60) Provisional application No. 60/202,191, filed on May 5, 2000.

(51) Int. Cl. F26B 19/00

(52) U.S. Cl. 34/201

(57) ABSTRACT

The present invention is that of a new and improved ball dryer that is designed to pull the moisture away from wet and waterlogged balls, primarily footballs, at an accelerated rate, preferably 10 minutes or less. The present invention would be battery-powered or have a generator for a power source. The present invention works by blowing tremendous amounts of air by the ball. Alternatively, the present drying apparatus mechanism works as a high-powered dehydrator or as a convectional oven.

### I. BACKGROUND OF THE INVENTION

The present invention is that of a new and improved ball dryer that is designed to pull the moisture away from wet and waterlogged balls at an accelerated rate, preferably 10 minutes or less.

### II. DESCRIPTION OF THE PRIOR ART

U.S. Pat. No. 4,137,040, issued to Starkey et al., discloses a football drying machine having a frame and wheels so that it may be moved about.

U.S. Pat. No. 4,055,002, issued to Roberts et al., discloses a portable apparatus for drying wet footballs which comprises a housing supported on wheels and includes a drying chamber for receipt of a wet football therein.

U.S. Pat. No. 4,026,310, issued to Beauregard, discloses a portable cabinet which is fitted with means for washing and drying one or more footballs.

### III. SUMMARY OF THE INVENTION

The present invention is that of a new and improved ball dryer that is designed to pull the moisture away from wet and waterlogged balls, primarily footballs, at an accelerated rate, preferably 10 minutes or less. The present invention would be battery-powered or have a generator for a power source. The present invention works by blowing tremendous amounts of air by the ball. Alternatively, the present drying apparatus mechanism works as a high-powered dehydrator or as a convectional oven.

There has thus been outlined, rather broadly, the more important features of a ball dryer in order that the detailed description thereof that follows may be better understood and in order that the present contribution to the art may be better appreciated. There are, of course, additional features of the ball dryer that will be described hereinafter and which will form the subject matter of the claims appended hereto.

In this respect, before explaining at least one embodiment of the ball dryer in detail, it is to be understood that the ball dryer is not limited in its application to the details of construction and to the arrangements of the components set forth in the following description or illustrated in the drawings. The ball dryer is capable of other embodiments and being practiced and carried out in various ways. Also, it is to be understood that the phraseology and terminology employed herein are for the purpose of descriptions and should not be regarded as limiting.

As such, those skilled in the art will appreciate that the conception, upon which this disclosure is based, may readily be utilized as a basis for the designing of other structures, methods and systems for carrying out the several purposes of the present ball dryer. It is important, therefore, that the claims be regard as including such equivalent constructions insofar as they do not depart from the spirit and scope of the present invention.

It is therefore an object of the present invention to provide a ball dryer which has all of the advantages of the prior art and none of the disadvantages.

It is another object of the present invention to provide a ball dryer which may be easily and efficiently manufactured and marketed.

It is another object of the present invention to provide a ball dryer which is of durable and reliable construction.

It is yet another object of the present invention to provide a ball dryer which is economically affordable and available for relevant purchasing government entities and professional teams.

Other objects, features and advantages of the present invention will become more readily apparent from the following detailed description of the preferred embodiment when considered with the attached drawings and appended claims.

### IV. BRIEF DESCRIPTION OF THE DRAWINGS

FIG. 1 shows a front perspective view of the first preferred embodiment of the present invention.

FIG. 2 shows a front perspective view of a close-up of the location where the ball holder and ball would be inserted into the present invention.

FIG. 3 shows a perspective close-up view of the drying unit of the present invention with the drying unit including a fan, hot air generating source, and a flow-through air system.

FIG. 4 shows a perspective close-up view of the drying unit of the present invention with the drying unit including a dessicator.

FIG. 5 shows a perspective close-up view of the drying unit of the present invention with the drying unit including a convectional oven.

### V. DESCRIPTION OF THE PREFERRED EMBODIMENT

Referring now to FIG. 1, ball dryer 2 is shown. Ball dryer 2 comprises frame 4, handle 6, power means 8, drying unit 10, wheels 12 and 14, and latch 16.

Frame 4 includes two vertical support bars 5 and 7 and a lower horizontal support bar 9. Lower horizontal support bar 9 is approximately 16 inches in length and rests on axle 11, which connects wheels 12 and 14. Each of the two vertical support bars extends straight upward from an end of lower horizontal bar 9. Each of the two vertical support bars has an inner face and an outer face, with the inner face including mounting means for both power means 8 and drying unit 10.

Power means 8 would be attached to the inner face of vertical support bars 5 and 7 via the mounting means located on the inner face of vertical support bars 5 and 7. Power means 8 also rests on lower horizontal support bar 9. Power means 8 can either be a large battery or a generator. Power means 8 would be electronically connected to drying unit 10 so that drying unit 10 would properly receive power from power means 8.

Drying unit 10 would be attached to the inner face of vertical support bars 5 and 7 via the mounting means located on the inner face of vertical support bars 5 and 7. Drying unit 10 would be mounted within the upper portion of vertical support bars 5 and 7. Drying unit 10 would work either by blowing large amounts of air toward and around a ball located in drying unit 10, or alternatively, would act as a high-powered desiccator and dehydrate a ball placed within drying unit 10. The width of drying unit 10 would be approximately 17 inches, the height of drying unit 10 would be approximately 12 inches, and the depth of drying unit 10 would be approximately 11 inches.

Handle 6 would be attached to the top of vertical support bars 5 and 7. Handle 6 would have a small horizontal extension bar extending outward from vertical support bar 5, and would have another small horizontal extension bar extending outward from vertical support bar 7. Handle 6 would have a connecting horizontal bar which would connect the ends of the two small horizontal extension bars.

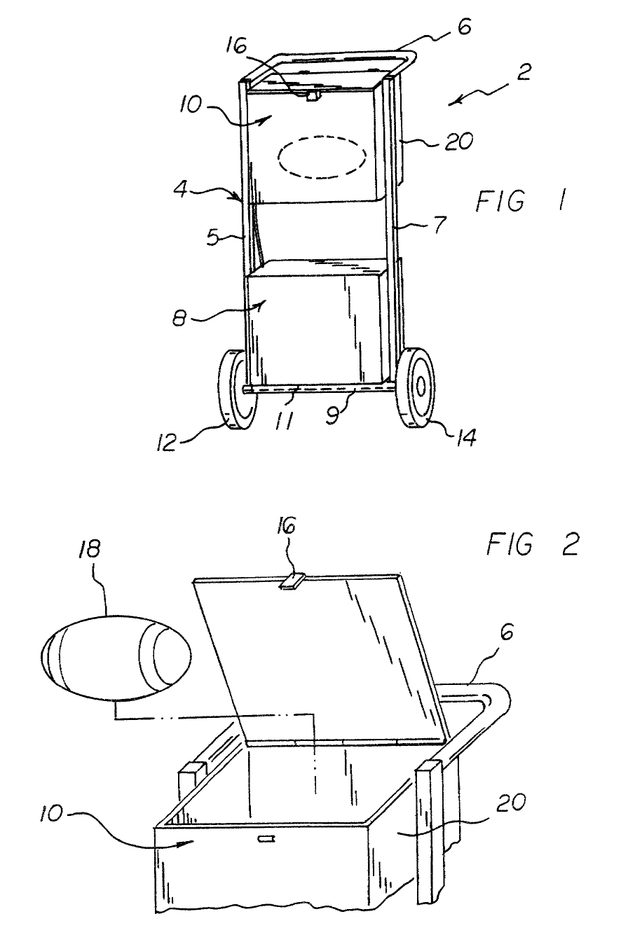

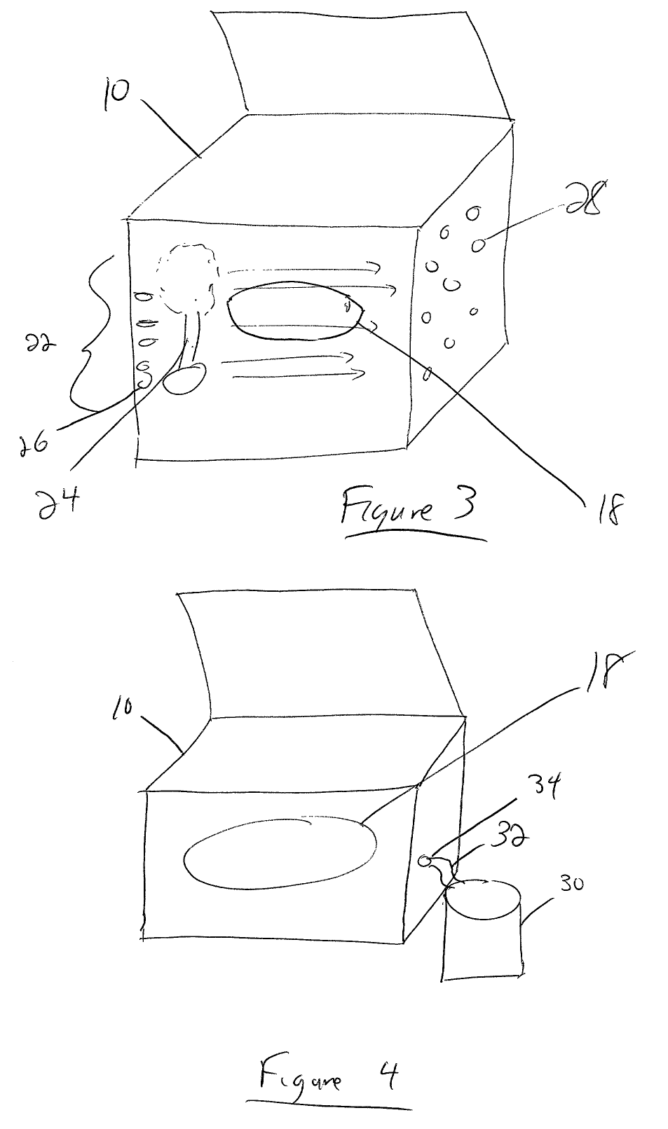

In FIG. 2, football 18 is shown being placed within ball holder 20. The use of football 18 is not meant to be limiting, as the present invention could be used with balls in other sports, such as soccer, rugby, and other sports. The use of a football 18 with the present invention is expected to be common, and therefore, a football 18 is used to illustrate the use of the present invention.

Ball holder 20 includes latch 16 and is designed to allow football 18 to be placed within drying unit 10. Latch 16 allows ball holder 20 to be fixedly placed within drying unit 10, which also allowing ball holder 20 to be easily removed at the will of a user. Latch 16 is attached to the underside of cover 21.

A drying apparatus 22 within drying unit 10 would be responsible for performing the necessary actions required to dry a wet ball placed within ball holder 20. In one embodiment of the present invention, drying apparatus 22 would include a fan 24 which would blow hot air rapidly over a football 18 within ball holder 20. Heat source 26 would generate the hot air necessary for fan 24. Ball holder 20 would have a plurality of air exit holes 28 for this embodiment to have continual air flow. This embodiment is shown in FIG. 3.

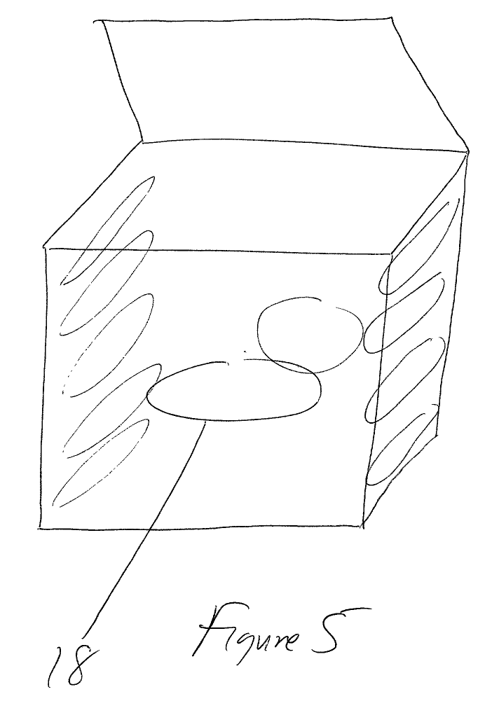

In another embodiment of the present invention, as shown in FIG. 4, drying apparatus would comprise a desiccator 30. Desiccator 30 would function by creating a vacuum within ball holder 20 once the lid 21 would be closed. Desiccator 30 would preferably be located outside of drying unit 10 and would use a vacuum pump in order to properly create a vacuum within drying unit 10. Desiccator 30 would have a vacuum hose with two ends, a first end and a second end, with the first end being connected to the desiccator 30 and the second end connected to the inside volume of air within drying unit 10 through hole 34. Desiccator 30 would pump some of the volume of the air within ball holder 20 to the outside world, creating a partial vacuum. This partial vacuum would cause some or most of the water within a waterlogged football 18 to exit football 18. Care would have to be taken to make sure that desiccator 30 would not create too strong of a vacuum and cause football 18 to blow up or become overinflated.

In another embodiment of the present invention, as shown in FIG. 5, drying apparatus would comprise a convectional oven 36. Oven 36 would include a plurality of heat sources 38, along with a temperature setting dial 40. The heat sources would be located within drying unit 10, while the dial 40 would preferably be located on an outside surface of drying unit 10.

What I claim as my invention is:

1. A ball dryer comprising:
(a) a frame comprising a lower horizontal support bar and two vertical support bars, a first vertical support bar and a second vertical support bar, the lower horizontal support bar having two ends, a first end and a second end, the first vertical support bar having two ends, a first end and a second end, the first vertical support bar also having two surfaces, an inner surface and an outer surface, the first end of the first vertical support bar fixedly connected to the first end of the lower horizontal support bar at a ninety degree angle, the second vertical support bar having two ends, a first end and a second end, the second vertical support bar also having two surfaces, an inner surface and an outer surface, the first end of the second vertical support bar fixedly connected to the second end of the lower horizontal support bar at a ninety degree angle,
(b) a pair of wheels, a first wheel and a second wheel,
(c) an axle having two ends, a first end and a second end, the axle travelling through the lower horizontal support bar, the first wheel connected to the first end of the axle, and the second wheel connected to the second end of the axle,
(d) a drying unit comprising an outer casing, the outer casing being box-shaped and connected to the inner surface of the first vertical support bar and the inner surface of the second vertical support bar, the drying unit including a cover pivotally attached to the drying unit, the drying unit also including a latch to removably secure the cover in a closed position if desired,
(e) a drying apparatus located within the drying unit,
(f) power means for providing power to the drying apparatus, the power means attached to the frame, and
(g) wiring to connect the power means to the motor.

2. A ball dryer according to claim 1 wherein the ball dryer further comprises a handle, the handle having two ends, a first end and a second end, the first end of the handle being fixedly attached to the second end of the first vertical support bar, and the second end of the handle being fixedly attached to the second end of the second vertical support bar.

3. A ball dryer according to claim 2 wherein the drying apparatus comprises a fan located within the drying unit, the fan placed facing the location where a wet ball would be placed within the drying unit, a heat source located within the drying unit, the heat source heating up air within the drying unit, and a plurality of air exit holes located on at least one surface of the drying unit.

4. A ball dryer according to claim 2 wherein the drying apparatus comprises a desiccator located outside of the drying unit, the desiccator functioning to remove a volume of air from within the drying unit once a wet ball has been placed within the drying unit and the cover on the drying unit has been closed, wherein the drying apparatus further comprises a vacuum hose having two ends, a first end and a second end, the first end of the vacuum hose connected to the desiccator and the second end of the vacuum hose connected to the inside volume of air within the drying unit.

5. A ball dryer according to claim 2 wherein the drying apparatus comprises a convectional oven located inside of the drying unit, the convectional oven functioning to heat up the air from within the drying unit once a wet ball has been placed within the drying unit and the cover on the drying unit has been closed, the drying unit further comprising a plurality of heat sources located within the drying unit, the drying unit further comprising a temperature setting dial located on an external surface of the drying unit, the temperature setting dial designed to control the amount of electricity passing into the plurality of heat sources.

6. A ball dryer according to claim 2 wherein the power means is attached to the lower horizontal support bar of the frame.

7. A ball dryer according to claim 2 wherein the power means is attached to the at least one vertical support bar of the frame.

8. A ball dryer according to claim 2 wherein the power means is a battery.

9. A ball dryer according to claim 2 wherein the power means is a generator.
